(19) United States
(12) Patent Application Publication
(10) Pub. No.: US 2009/0281366 A1
(43) Pub. Date: Nov. 12, 2009

(54) FLUID CUSHION SUPPORT FOR IMPLANTABLE DEVICE

(76) Inventor: DAVID L. BASINGER, Loveland, CO (US)

Correspondence Address: MARSH, FISCHMANN & BREYFOGLE LLP, 8055 East Tufts Avenue, Suite 450, Denver, CO, 80237, US

(21) Appl. No.: 12/117,929

(22) Filed: May 9, 2008

(51) Int. Cl. H04R 25/00

(52) U.S. Cl. 600/25

(57) ABSTRACT

A system for reducing the vibration sensitivity of an implantable microphone without an equal or greater reduction in sound sensitivity. The system reduces non-ambient vibrations by placing at least one compliant member into the path of transmission for tissue-borne vibration, but not into the path for ambient sound-induced vibration. More particularly, a fluid filled compliant member is disposed between an implanted microphone and an implant wearer's skull. The compliant member and the implanted microphone define a supported system having a natural or resonant frequency. This natural frequency may be set to a value to advantageously isolate the microphone against transmitted vibration.

### FIELD OF THE INVENTION

The present invention relates to implanted assemblies, e.g., as employed in hearing aid instruments, and more particularly, to isolating implanted assemblies from undesired sources of vibration.

### BACKGROUND OF THE INVENTION

In the class of hearing aid systems generally referred to as implantable hearing instruments, some or all of various hearing augmentation componentry is positioned subcutaneously on or within a patient's skull, typically at locations proximate the mastoid process. In this regard, implantable hearing instruments may be generally divided into two sub-classes, namely semi-implantable and fully implantable. In a semi-implantable hearing instrument, one or more components such as a microphone, signal processor, and/or transmitter may be externally located to receive, process, and inductively transmit an audio signal to implanted components such as a transducer. In a fully implantable hearing instrument, typically all of the components, e.g., the microphone, signal processor, and transducer, are located subcutaneously. In either arrangement, an implantable transducer is utilized to stimulate a component of the patient's auditory system (e.g., ossicles and/or the cochlea).

By way of example, one type of implantable transducer includes an electromechanical transducer having a magnetic coil that drives a vibratory actuator. The actuator is positioned to interface with and stimulate the ossicular chain of the patient via physical engagement. (See e.g., U.S. Pat. No. 5,702,342). In this regard, one or more bones of the ossicular chain are made to mechanically vibrate, which causes the ossicular chain to stimulate the cochlea through its natural input, the so-called oval window.

As may be appreciated, hearing instruments that propose utilizing an implanted microphone will require that the microphone be positioned at a location that facilitates the receipt of acoustic signals. For such purposes, an implantable microphone may be positioned (e.g., in a surgical procedure) between a patient's skull and skin, typically at a location rearward and upward of a patient's ear (e.g., in the mastoid region). For a wearer of such a hearing instrument (e.g., middle ear transducer or cochlear implant stimulation systems), undesirable vibration (e.g., non-sound vibration) originating within the user's skull and/or tissue may be detected and amplified by the microphone to an undesirable degree. For instance, a middle ear transducer used with a hearing instrument may create such vibration. In this case, detection and amplification of the vibration can lead to objectionable feedback.

Unwanted vibration can also arise naturally from talking or chewing. In both instances, undesired vibrations are transmitted through the user's skull or tissue to the site of the implanted microphone where a component of these undesired vibrations may be received by a microphone diaphragm and where the skin and tissue covering such a microphone diaphragm may undesirably increase the overall vibration sensitivity of the system. In this regard, while proposed implantable hearing aid instruments are sensitive to the sources of undesired vibration, they are intended by design to be sensitive to “ambient” sound vibrations from outside a user's body.

It is therefore desirable to have a means of reducing system response to sources of non-ambient (i.e., undesired) vibration, without significantly affecting the desired ambient sound vibration sensitivity.

### SUMMARY OF THE INVENTION

In order to reduce non-ambient vibration sensitivity without an equal or greater reduction in ambient sound vibration sensitivity, it is necessary to attenuate the non-ambient vibrations received by an implanted microphone preferentially. The present invention accomplishes this goal by placing at least one compliant support member into a transmission path of tissue borne/non-ambient vibrations (e.g., vibrations transmitted via bone and/or soft tissue) without substantially interfering with a transmission path for ambient sound-induced vibrations. For discussion purposes, the invention is primarily set forth in relation to reducing tissue-borne/non-ambient vibrations in systems where a microphone is attached to a patient's skull. However, it will be appreciated that the microphone may be implanted at locations other than the skull of a patient. For instance, a microphone may be implanted on the neck or chest of a patient. In such an application, non-ambient vibrations caused by the heart, muscle movement, and/or clothing may be present. Irrespective of the location of an implanted microphone, what is important is that the compliant support member be operative to attenuate non-ambient vibrations.

In one aspect, a system and method (i.e., utility) for isolating an implantable hearing aid microphone from non-ambient vibrations (e.g., non-desired vibrations) is provided where a fluid filled compliant support member is utilized to at least partially isolate an implant housing (e.g., which may support a microphone diaphragm) from non-ambient vibrations and/or attenuate such non-ambient vibrations. The utility includes positioning a compliant support member at a subcutaneous location. In one arrangement, a base member is provided that is adapted for connection to a subcutaneous location. In such an arrangement, the compliant support surface is connected to the base member. In any arrangement, the compliant support surface defines a mounting surface for compliantly supporting an implantable device. At least a portion of the compliant support surface is elastically deformable relative to an enclosed volume of fluid. In this regard, the compliant support surface and the enclosed volume of fluid may be disposed between, for example, an implantable microphone and a source of non-ambient vibration. Such a microphone may be operatively interconnected to or integral with an implant housing that is operative to utilize an output of the microphone to generate an auditory stimulation signal for use with an auditory stimulator.

The enclosed volume is typically hermetically sealed to prevent intrusion of bodily fluids when implanted. The fluid within the enclosed volume may be any fluid that permits compression and/or deflection of the compliant support surface relative to the enclosed volume. If a non-compressible liquid is utilized, the liquid within the enclosed volume may fluidly communicate with, for example, an expansion chamber. Such an expansion chamber may be at least partially gas filled or may allow for physical deformation (e.g., expansion of bellows, use of an elastic chamber etc.) to accommodate liquid displaced from the enclosed volume in response to movement of the compliant support surface. Likewise, expansion chambers may be utilize when gases are utilized to fill the enclosed volume. Further, the type of gas may be selected to impart desired characteristics. For instance, a gas having a molecular weight that is less than air (e.g., helium, nitrogen, etc) may be utilized to improve the compliancy of the compliant support surface. However, it will be appreciated that air may be utilized. The pressure within the enclosed volume may be selected to provide a desired spring constant and/or damping coefficient for the compliant support surface. If a liquid is utilized, the viscosity an/or other characteristics of the liquid may also be selected to provide desired properties.

As noted above, the apparatus is adapted to compliantly support an implantable device. Such an implantable device may include, without limitation, an implant housing for subcutaneously housing one or more hearing aid components. Typically, an implant housing may be disposed on the compliant support surface. Accordingly, the compliant support surface may be disposed between an underlying mounting surface (e.g., underlying bone and/or a base member) and the implantable housing. Likewise, the enclosed volume may be disposed between the mounting surface and the compliant support surface. In one arrangement, the entirety of such an implant housing is disposed over the enclosed volume. In this regard, the entirety of the housing may be elastically deflectable relative to the enclosed volume. In one particular arrangement, an implant housing includes a microphone diaphragm. In such an arrangement, the microphone diaphragm may be supported by the apparatus such that the diaphragm may be exposed to overlying patient tissue in order to receive ambient acoustic signals.

The compliant support surface and a supported implant housing may be preassembled and may be implanted as a combined assembly. Likewise, if a base member is utilized, the base member may also be preassembled with the compliant support surface. In another arrangement, a base member and compliant support member may be implanted and may allow for subsequent mounting of an implantable device thereon. In this regard, the implantable housing may be secured to the complaint support surface using any appropriate means, including, without limitation, adhesives and/or welding.

A compliant support surface may be formed of any component that provides a desired compliancy relative to the enclosed volume. In one arrangement, the compliant support surface is formed of a thin membrane. For instance, such a membrane may be disposed over a recessed surface in the base. In such an arrangement, the compliant support surface and base may collectively define the enclosed volume. In another arrangement, the compliant support surface defines the enclosed volume. In such an arrangement, the compliant support surface may form a bladder that may be positioned on a subcutaneous surface and/or attached to the base member. Such a bladder may be formed of, for example, a thin walled vessel made of any appropriate biocompatible material. Likewise, other components may also be formed of such biocompatible materials, which may include, without limitation, titaniums, nitinol, gold plated alloys and stainless steels.

According to another aspect, a system for use in isolating an implantable hearing aid microphone from non-ambient vibrations is provided. The system includes an implant housing for housing at least one hearing aid component subcutaneously and a microphone diaphragm that is supported relative to the implant housing. The system further includes a compliant support member for compliantly supporting the implant housing. The compliant support member includes a fluid filled enclosed volume. Generally, at least a portion of the compliant support member is elastically deflectable relative to the enclosed volume. Likewise, the implant housing may be elastically deflectable relative to at least a portion of the enclosed volume in order to attenuate non-ambient vibrations.

Various refinements exist of the features noted in relation to the subject aspect of the present invention. For instance, the microphone may include a diaphragm, a transducer and a microphone housing (e.g., for holding the diaphragm and transducer relative to one another). The microphone may also include additional componentry such as, without limitation, multiple diaphragms and/or multiple transducers, which may include any of a variety of electro-acoustic transducers. Likewise, an implant housing (e.g., which houses the microphone or is operatively is connected to the microphone) may also house other hearing instrument componentry such as, without limitation, a processor(s), circuit componentry, and a rechargeable energy storage device(s) etc. Such an implant housing may further provide one or more signal terminal(s) for electrical interconnection (e.g., via one or more cables, pin connectors, etc.) to an auditory stimulator such as, for example, an implantable transducer for a middle ear stimulation device or a cochlear stimulation device.

In one arrangement, the compliant support member may be interposed between a patient's bone and an implantable housing containing a microphone. In this regard, the compliant support member may act as an isolating support for the housing and microphone, thereby changing the natural, or resonant, frequency of the system that includes, at a minimum, the compliant support member and the microphone.

This resonant frequency may be designed to have a value that is advantageous in isolating the microphone against sources of non-ambient vibration. Preferably, the compliant support member is designed such that the suspended system has a natural, or resonant, frequency that is less than the lowest frequency of non-ambient vibration to be attenuated. It is more desirable that the natural frequency be less than ½ the lowest frequency in the frequency range to be attenuated. It is still more desirable that the natural frequency be less than ⅕ the lowest frequency in the frequency range to be attenuated. For example, when the natural frequency of the suspended system is ⅕ that of the lowest frequency to be attenuated, transmission of that frequency will be reduced to 1/24^{th} its original value. In this way, the present invention reduces the system's sensitivity to non-ambient vibrations, while preserving its sensitivity to ambient vibrations (e.g., desired sound vibrations).

### BRIEF DESCRIPTION OF THE DRAWINGS

FIG. 1 illustrates one embodiment of a fully implantable hearing instrument as implanted in a wearer's skull;

FIG. 2 is a side view of one embodiment of the implantable hearing instrument as implanted relative to a wearer's skull;

FIG. 3 shows an exploded perspective view of one embodiment of the present invention;

FIG. 4 shows an assembled perspective view of the embodiment of FIG. 3; and

FIG. 5 shows a cross-sectional view of one embodiment of the present invention as implanted relative to a wearer's skull.

FIG. 6 shows the attenuation of force by the cross-sectional view of FIG. 5.

FIG. 7 shows a cross-sectional view of a further embodiment of the present invention.

FIG. 8 shows a cross-sectional view of a further embodiment of the present invention.

FIG. 9A shows a cross-sectional view of a further embodiment of the present invention.

FIG. 9B shows a mounting plate utilized with the embodiment of FIG. 9A.

FIG. 10 shows a cross-sectional view of a further embodiment of the present invention.

### DETAILED DESCRIPTION OF THE INVENTION

Reference will now be made to the accompanying drawings, which at least assist in illustrating the various pertinent features of the present invention. In this regard, the following description of a hearing aid device is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain the best modes known of practicing the invention and to enable others skilled in the art to utilize the invention in such, or other embodiments and with various modifications required by the particular application(s) or use(s) of the present invention.

### Hearing Instrument System:

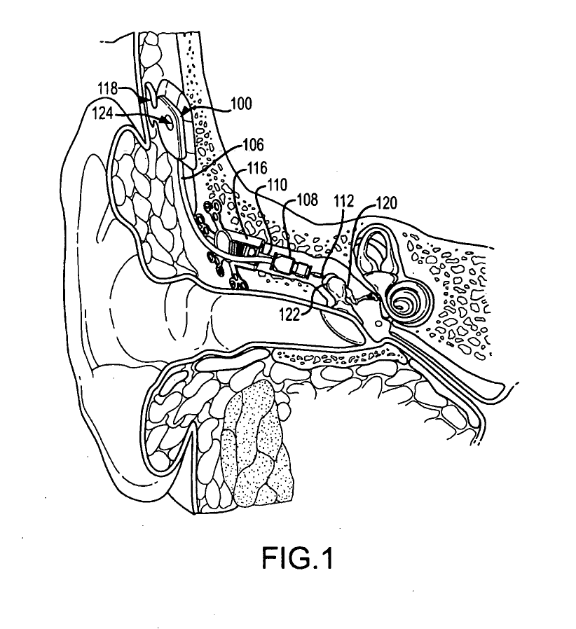

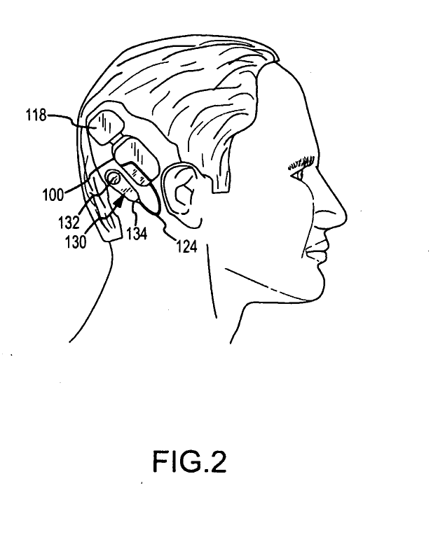

FIGS. 1 and 2 illustrate one application of the present invention. As illustrated, the application comprises a fully implantable hearing instrument. As will be appreciated, certain aspects of the present invention may be employed in conjunction with semi-implantable hearing instruments as well as other fully implantable hearing instruments (e.g., cochlear implant systems, vegal nerve stimulators, etc.). Therefore the illustrated application is for purposes of illustration and not limitation.

In the system illustrated in FIGS. 1 and 2, a biocompatible implant housing 100 is located subcutaneously on a patient's skull. The implant housing 100 includes a signal receiver 118 (e.g., comprising a coil element) that is interconnected to a microphone assembly 130 via a signal wire 124. The implant housing 100 may be utilized to house a number of components of the implantable hearing instrument. For instance, the implant housing 100 may house an energy storage device and a signal processor. Various additional processing logic and/or circuitry components may also be included in the implant housing 100 as a matter of design choice. In the present arrangement, the signal processor within the implant housing 100 is electrically interconnected via a signal wire 106 to a transducer 108.

The transducer 108 is supportably connected to a positioning system 110, which in turn, is connected to a bone anchor 116 mounted within the patient's mastoid process (e.g., via a hole drilled through the skull). The transducer 108 includes a connection apparatus 112 for connecting the transducer 108 to an auditory component of the patient. In the present embodiment, the transducer is connected to the ossicular chain 120. However, it will be appreciated that connection to another auditory component (e.g., oval window, round windows, cochlea, etc.) is possible and is within the scope of the present invention. In a connected state, the connection apparatus 112 provides a communication path for acoustic stimulation of a portion of the ear, such as the ossicles 120, e.g., through transmission of vibrations to the incus 122 or other ossicles bone.

The microphone assembly 130 may be spaced from the implant housing 100 to facilitate mounting to the skull of a patient. However, it will be appreciated that the microphone may be mounted in other locations such as, without limitation, the neck or sub-clavically. Further, in other embodiments, the microphone assembly 130 may also be integrated within the main housing 100. The microphone assembly 130 includes a diaphragm 132 that is positioned to receive ambient acoustic signals through overlying tissue, a microphone transducer (not shown) for generating an output signal indicative of the received ambient acoustic signals, and a housing 134 for supporting the diaphragm 132 relative to the transducer.

During normal operation, acoustic signals are received subcutaneously at the diaphragm 132 of the microphone assembly 130. The microphone assembly 130 generates an output signal that is indicative of the received acoustic signals. The output signal is provided to the implant housing 100 via a signal wire 124. Upon receipt of the output signal, a signal processor within the implant housing 100 processes the signals to provide a processed audio drive signal via a signal wire 106 to the transducer 108. As will be appreciated, the signal processor may utilize digital processing techniques to provide frequency shaping, amplification, compression, and other signal conditioning, including conditioning based on patient-specific fitting parameters. The audio drive signal causes the transducer 108 to transmit vibrations at acoustic frequencies to the connection apparatus 112 to effect the desired sound sensation via mechanical stimulation of the incus 122 of the patient.

As noted above, the microphone assembly 130 may be mounted on the skull of a patient. Accordingly, non-ambient vibrations within the skull that may result from, for example, transducer feedback and/or biological sources (e.g., talking and/or chewing) may be transmitted to the microphone assembly 130. Such non-ambient vibration may result in relative movement between the microphone assembly 130 and overlying tissue. More specifically, relative movement may exist between the microphone diaphragm 132 and the overlying tissue. This relative movement may deflect the diaphragm generating a response in the microphone transducer output. Further, such non-ambient vibration may cause movement (e.g., acceleration) of the tissue, which may result in diaphragm deflection. Through these processes, such non-ambient vibrations may be represented in the output signal of the microphone as undesired signals. Further, such non-ambient vibrations typically interfere with desired signals (e.g., ambient vibrations/sound), which may result in reduced speech intelligibility and/or limit the available gain for the hearing system. Accordingly, it may be desirable to isolate the microphone assembly 130 from one or more sources of non-ambient vibrations.

### Vibration Isolation:

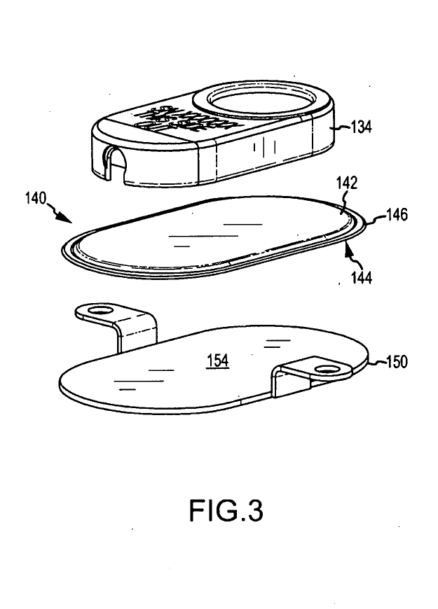

FIGS. 3-5 show the use of a fluid filled compliant support member for reducing non-ambient/tissue-borne vibrations that may be received by an implanted microphone or microphone assembly 130. As discussed herein, the term tissue-borne and/or non-ambient vibrations is meant to represent those vibrations that do not originate as ambient sound. Generally, ambient sound vibrations are received through tissue above an implanted microphone diaphragm and cause desired microphone diaphragm vibrations while non-ambient vibrations originate from within the body and are often the source of undesired microphone diaphragm vibrations.

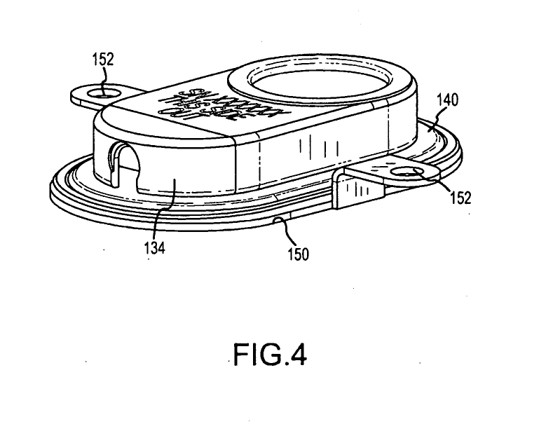

In one embodiment shown in FIGS. 3 and 4, a fluid filled compliant support member 140 is utilized to reduce non-ambient vibrations that may be transmitted from an implant mounting surface to an implant housing. In this regard, the compliant support member 140 is designed to be disposed between an implant housing 134 and a mounting surface thereby cushioning the implant housing from vibrations within the mounting surface. In the present embodiment, the implant housing is the housing 134 of the microphone assembly 130. However, it will be appreciated that the fluid filled compliant support member may be utilized with other implantable housings.

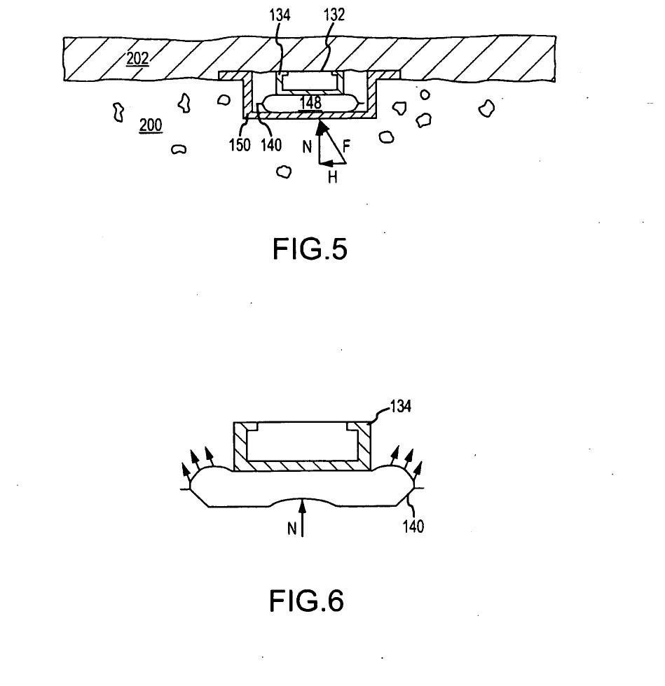

As shown, the compliant support member 140 is formed from an upper membrane 142 and a lower membrane 144 that are sealably connected by a seam 146 and which collectively define an enclosed volume (see, e.g., FIG. 5). In order to define an enclosed volume, the membranes are recessed members having a rim or edge that extends above a generally flat surface of each membrane. These rims/edges are interconnected at the seam. In this regard, when interconnected, first and second membranes 142, 144 define a bladder having an enclosed volume 148. In one embodiment, the upper and lower membranes are made of a biocompatible metal or metal alloy (e.g., titanium or gold, etc.). In such an arrangement the seam may be a laser welded or otherwise adhered together. In any case, the seam between the first and second membranes 142, 144 forms a fluid tight seal therebetween. While the membranes 142, 144 may be made of any biocompatible material including metals, metal alloys and synthetic materials, each membrane is formed of a flexible material.

As will be appreciated, if a metallic membrane is utilized such as, for example, titanium, the thickness of the metal may be such that the membrane maintains some flexibility. For instance, a titanium membrane may have a thickness of between about 5 um and 30 um. In any case, it is desirable that the resulting compliant support member 140 allow for some deformation.

The enclosed volume 148 may be filled with any appropriate fluid including liquids and gases. In the present embodiment, where the enclosed volume is sealed does not allow for expansion, a compressible fluid is used to filled the volume. Specifically, the enclosed volume is filled with a gas. As will be appreciated, the first and second membranes 142, 144 may be interconnected in a controlled environment that may allow for selectively controlling the gas that is disposed with the enclosed volume 148. For instance, if the membranes 142, 144 are welded together, such welding may be performed in an inert gas filled environment such that gas enclosed within the volume 148 may be an inert gas (e.g., helium). However, this is not a requirement, and it will be appreciated that the enclosed volume may be air filled. Further, it will be appreciated that pressure of the environment where the membranes are connected may also be controlled such that the pressure within the enclosed volume may be selectively controlled. In the present embodiment, the gas or air within the enclosed volume 148 is not pressurized such that the resulting compliant member is generally limp. In this regard, a compliant support member may have a very low resonant frequency, which may be below the resonant frequencies associated with tissue-borne vibrations to permit attenuation of the same.

As may be appreciated, the source of a particular tissue-borne vibration typically determines the frequency range to be attenuated. Two such sources, and their associated frequency ranges to be attenuated by the present invention, are now described. First, tissue-borne vibration caused by a middle ear stimulation transducer may be transmitted back to the microphone creating a possibility for feedback. The resonance/response of the stimulation transducer is controlled by the design of the stimulation transducer itself. It is also known that the skin and skull of the patient transmits some frequencies better than others. Therefore, the range of frequencies for feedback mitigation purposes is generally the audio band of 20 Hz to 20 kHz. However, as a practical matter, this is to be balanced by the expected output of the transducer. Most hearing aid devices limit response to frequencies below 10 KHz and often do not address sounds below 250 Hz. Therefore, a range of 250 Hz to 10 KHz is expected. A practical implementation however, will likely concentrate on even more specific ranges. Typically, a patient or group of patients will need more transducer output at a specific range of frequencies, for example 2 KHz to 4 KHz. Second, tissue-borne vibration caused by biological sources such as chewing and speech are dominated by more low frequency content. These vibrations may be attenuated or shaped to specific levels for a “natural” sound. This range of interest is approximately 250 Hz to 3 KHz. The fluid filled compliant support member permits attenuating vibrations for ranges sufficient to accommodate both such sources.

In order to utilize the compliant support member 140 formed by first and second membranes 142, 144, a mounting plate 150 may be provided. As shown, the mounting plate 150 has a substantially flat top surface 154 that is sized to receive a mating surface (e.g., bottom surface of the lower membrane 144) of the compliant support member 140. The mounting plate 150 further includes one or more apertures 152 that may be utilized to secure the mounting plate to a subcutaneous location. For instance, screws, sutures or other fasteners may be disposed through the apertures 152 and interconnect to underlying tissue. At such time, the mounting plate 150 and supported member 140 may provide a platform for compliantly supporting an implantable housing 134 that is disposed on the compliant support member 140. In the present embodiment, the compliant support member 140 may be adhered or welded to the top surface 154 of the mounting plate 150. However, it will be appreciated that other mounting methods are possible and are within the scope of the present invention.

Once the compliant support member is mounted to the mounting plate 150 (which may be performed prior to an implant procedure), the upper surface of the upper membrane 142 is available for supporting an implantable housing. In the present embodiment, the microphone housing 134 of the pendant microphone assembly 130 may be disposed on top of the upper membrane 142. Again, different connection mechanisms (e.g., adhering, welding etc.) may be utilized to connect the microphone assembly to the upper membrane 142. Such connection may be performed during an implant procedure or prior to an implant procedure. In the latter regard, the microphone assembly 134, compliant support member 140 and mounting plate 150 may be interconnected prior to implantation and form a combined assembly for implantation. In the present embodiment, the size of the support surface of compliant support member is greater than the bottom surface of the implant housing 134. In this regard, the entirety of the housing 134 may be disposed above the enclosed volume. That is, the entire implant housing may be compliantly supported.

Once implanted, the compliant support member 140 forms a barrier between a source of non-ambient vibration (e.g., skull borne vibrations, transducer feedback, etc.) and the microphone assembly. The compliant support member 140 and the implant housing 134 also form a suspended system. As will be appreciated, the physical characteristics of the compliant support member 140 and/or the supported housing may be selected in order to alter the natural frequency of the suspended system. This may allow for preferentially attenuating unwanted/non-ambient vibration. For enhanced vibration isolation, it may be desirable that the suspended system have a natural, or resonant, frequency substantially lower than the lowest frequency to be attenuated. For example, if the natural frequency of the suspended system is ⅕ that of the lowest frequency to be attenuated, transmission of that frequency will be reduced to 1/24^{th} its original value. Such an arrangement effectively results in a support having a low pass filter effect. Alternatively, the supported system may be designed to include high pass or band pass filtering effects. In the latter regard, the shape of the enclosed volume and/or fluidly connected volumes may be utilized to shape an overall response. In the embodiment shown, these goals may be achieved by selecting an appropriate combination of suspended mass, suspension compliance/spring constant (e.g., internal pressure, membrane thickness, membrane flexibility/thickness, etc.), and (optionally) suspension damping coefficient (e.g., fluid viscosity filling the enclosed volume).

FIG. 5 illustrates a cross-sectional view of the compliant support member as it would appear in use in relation to a patient's skull 200, and skin 202. In this regard, the implant housing 134 is disposed onto the upper membrane 142 of the compliant support member 140. The mounting plate 150, which supports the compliant support member is shown in conformal, or flush, contact in relation with the patient's skull 200. In this regard, a bone bed may be formed to receive the mounting plate, however, this is not a requirement.

The compliancy of the compliant support member 140 allows for damping non-ambient vibrations prior to those vibrations reaching the implant housing 134, which reduces relative movement between the microphone diaphragm 132 and overlaying tissue and thereby reduces the amount and/or amplitude of undesired signals in the microphone output. As shown, the implant support member 140 and microphone housing 134 are subjected to tissue-borne vibrational forces as represented by the forces as labeled f in FIG. 5. These forces f each have a normal component n (i.e., that is perpendicular to the microphone diagram 132) and a horizontal component h. For purposes of reducing tissue-borne vibration seen by the microphone diaphragm 132, the normal component n is of foremost interest as this component accounts for a majority of the relative movement between the microphone diaphragm 132 and overlying tissue 202, which results in undesired diaphragm deflection. However, the horizontal component may also contribute to undesired diaphragm deflection albeit to a lesser degree. In any case, these forces may cause relative movement that creates undesired vibrations in the diaphragm 132.

As shown in FIGS. 5 and 6, at least the normal component n of the vibration force f passes into the compliant support member 140. A significant portion of the normal component of the applied force is attenuated by the compliancy of the membrane elastically deflecting into the enclosed volume 148. By way example also consider such a normal force n as a point force impinging normally to a small surface of the lower membrane 144. This force deforms the surface of the membrane 144. The deformation absorbs energy by converting it into heat. This is a first order effect. Secondly, the remaining energy compresses the enclosed volume of fluid (air for example), which is then translated into pressure that in turn deforms all surfaces of the compliant support member from within the enclosed volume at least those that do not have rigid external support. This deformation is also converted from translational energy to heat. Further more the translation of energy now propagates a force that was initially normal to the surface of the lower membrane 144 into one that is distributed across the surfaces. Note that the membranes 142, 144, when fully assembled into a system, are rigidly supported by the connection of the microphone housing 134 on the top surface and the mounting plate 150 on the lower membrane surface. The areas of the compliant support member 140 that deform are largely comprised of the small surface areas near the seam 146. Any deformation in these areas will deform at an angle to the applied normal force. These forces will also be translated back into tissue and not toward the lower surface of the microphone housing 134. See FIG. 6 (not to scale).

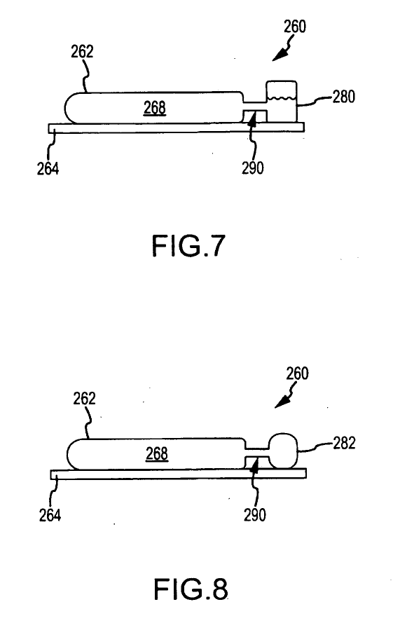

FIGS. 7 and 8 illustrate additional embodiments of compliant support members that may be utilized to subcutaneously support an implant housing. Specifically, FIG. 7 illustrates an embodiment that may be utilized to provide frequency shaping for the resonant frequency of a combined system (e.g., supported implant housing). Furthermore, the embodiment shown in FIG. 7 may be utilized with incompressible fluids. As shown, the compliant support member 260 of FIG. 7 includes a sealed bladder 262 that is disposed on a base member 264, which may be secured to a subcutaneous location. An enclosed volume 268 of the bladder 262 may be filled with a non-compressible fluid. In this regard, the enclosed volume 268 may be filled with a liquid. Accordingly, the viscosity of such liquid may be selected to provide the desired characteristics for a suspended system. That is, the viscosity of the fluid may be selected to alter the resonant frequency of implanted housing supported by the compliant support member 260. As shown, the internal volume 268 is interconnected to the expansion chamber 280 via a tube 290. The size of this tube, in conjunction with the viscosity of the liquid, may be selected to provide frequency dampening characteristics for the compliant support member 260.

The expansion chamber 280 may be partially filled with a gas to allow for compression when liquid is expelled from the enclosed volume 268 in response to compression of an implantable housing to the bladder 262. In an alternate embodiment (not shown), an expansion chamber may be an elastic or spring-loaded bellows arrangement. In this regard, the expansion chamber may not require the inclusion of gas for compression. Rather, the physical configuration of the expansion chamber may change based on the compression of the bladder 262.

FIG. 8 illustrates a variation to the embodiment FIG. 7. As shown, the embodiment FIG. 8 again includes a compliant support member 260 defined by a thin walled enclosure/bladder 262 having an enclosed volume 268. However, in this embodiment the enclosed volume 268 is gas filled. In this embodiment, compression of the compliant support member 260 expels gas within the internal volume 268 through a tube 290 into a rigid gas expansion chamber 282. The tube diameter and length in conjunction with the volume of the rigid expansion chamber 282 effectively define a Hemholtz resonator. As will be appreciated, the physical dimensions of the components may be selected such that the resulting resonator has a desired frequency response. Accordingly, such a resonator may be designed to provide frequency response/filtering over a predetermined frequency range.

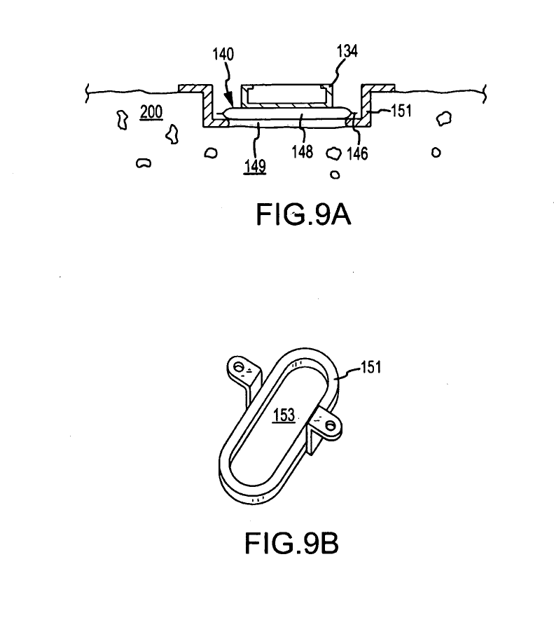

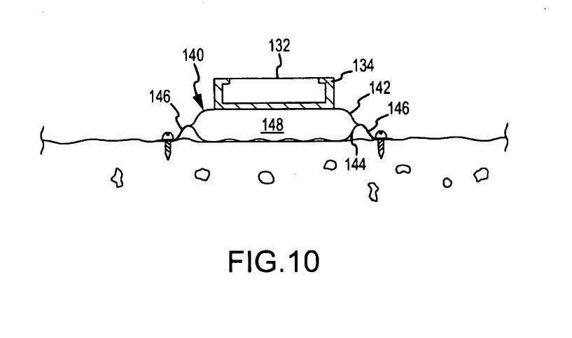

FIGS. 9A and 10 illustrate further embodiments of a compliant support member that may be utilized to subcutaneously support an implantable housing. As shown in FIG. 9A, the compliant support member 140 utilizes a base member 151 for connection to underlying bone/tissue 200. However, in this embodiment rather than the base member defining a solid plate, a central portion of the base member 151 has been removed to define an aperture 153. See FIG. 9B. In such an arrangement, a space 149 between the bottom of the compliant support member 140 and the top of a mounting surface (e.g., a skull surface) is filled with a volume of bodily fluid. As will be appreciated, the disposition of an additional fluid layer (i.e. body fluid) between the mounting surface and a supported implantable housing may result in additional attenuation of tissue borne forces. Alternatively, a lower surface of the compliant support member may be disposed through the aperture 153 (not shown) such that the seam 146 of the compliant support member is supported about the periphery of the aperture.

FIG. 10 illustrates a further embodiment wherein no separate base member is utilized with the compliant support member 140. As shown, the compliant support member 140 is simply formed as a thin walled member having upper and lower membranes 142, 144 defining an enclosed volume 148 that is filled with fluid. In such an arrangement, it may be desirable to place the compliant support member 140 on substantially flat subcutaneous support surface (e.g., a bone bed, skull surface, etc.). To secure the base-free compliant support member 140 relative to a desired subcutaneous location, sutures may extend over a surface of the compliant support member. Alternatively, where the compliant support members is formed from first and second membranes 142, 144 having attached lips forming a seam 146, one or more apertures may be formed through the seam 146. Accordingly, such apertures may be utilized to affix the compliant support member to underlining tissue.

Those skilled in the art will appreciate variations of the above-described embodiments that fall within the scope of the invention. As a result, the invention is not limited to the specific examples and illustrations discussed above, but only by the following claims and their equivalents.

What is claimed:

1. An apparatus for use in at least partially isolating an implantable device from subcutaneous vibrations, comprising:
a base member adapted to be connected to a subcutaneous tissue location;
a compliant support surface connected to said base, said compliant support surface member defining a mounting surface for an implantable device, wherein at least a portion of said compliant support surface is elastically deflectable relative to an enclosed volume of fluid.

2. The apparatus of claim 1, wherein said enclosed volume comprises a hermetically sealed volume.

3. The apparatus of claim 1 further comprising:
an implant housing for housing at least one hearing aid component subcutaneously, wherein said implant housing is disposed on said compliant support surface.

4. The apparatus of claim 3, wherein an entirety of said implant housing is disposed over said enclosed volume, wherein an entirety of said housing is elastically deflectable relative to said enclosed volume.

5. The apparatus of claim 4, wherein said implant housing further comprises:
a microphone diaphragm.

6. The apparatus of claim 1, wherein said enclosed volume of fluid is disposed between said compliant support surface and said base member.

7. The apparatus of claim 6, wherein said compliant support surface and said base member collectively define said enclosed volume.

8. The apparatus of claim 7, wherein said compliant support surface comprises a diaphragm sealably connected to said base member.

9. The apparatus of claim 1, wherein said compliant support surface comprises a bladder defining said enclosed volume, wherein said bladder is attached to said base member.

10. The apparatus of claim 9, wherein said bladder comprises a thin walled metallic element.

11. An apparatus for use in at least partially isolating an implantable device from subcutaneous vibrations, comprising:
a compliant bladder member, said compliant bladder member having:
an enclosed volume, wherein said enclosed volume is fluid filled;
a support surface for supporting an implantable housing, wherein at least a portion of said support surface is elastically deflectable relative to said enclosed volume.

12. The apparatus of claim 11, wherein said compliant bladder member comprises:
a thin walled metallic element.

13. The apparatus of claim 11, further comprising:
a base member adapted to be connected to a subcutaneous tissue location, wherein said base member supports said compliant bladder member.

14. The apparatus of claim 11, wherein said enclosed volume is fluidly connected to an expansion chamber, wherein fluid in said enclosed volume is displaced into said expansion chamber upon compression of said compliant bladder member.

15. The apparatus of claim 11, wherein said enclosed volume is hermetically sealed.

16. A system for isolating an implantable microphone from non-ambient vibrations, comprising:
an implant housing for housing at least one hearing aid component subcutaneously;
a microphone diaphragm supported relative to said implant housing; and
a compliant support member for compliantly supporting said implant housing, said compliant support member having an enclosed volume filled with a fluid.

17. The apparatus of claim 16, wherein at least a portion of said compliant support member is elastically deflectable relative to said enclosed volume of fluid.

18. The apparatus of claim 16, wherein said enclosed volume is hermetically sealed.

19. The apparatus of claim 16, wherein said enclosed volume is in fluid communication with an expansion chamber, wherein fluid in said enclosed volume is displaced into said expansion chamber upon compression of said compliant support member.

20. The apparatus of claim 16, wherein an entirety of said implant housing is disposed over said enclosed volume, wherein an entirety of said housing is elastically deflectable relative to said enclosed volume.

21. The apparatus of claim 16, wherein said fluid comprises a gas.

22. The apparatus of claim 16, wherein said compliant support member, said implant housing and said microphone diaphragm supported by said implant housing define a supported system having a natural frequency of less than about 2000 Hz.

23. The apparatus of claim 16, wherein said supported system has a natural frequency of less than about 400 Hz.

24. A methods for use in at least partially isolating an implantable device from subcutaneous vibrations, comprising:
positioning a compliant bladder member at a subcutaneous mounting location, said compliant bladder member having an enclosed volume filled with fluid;
locating an implantable device housing on a support surface of said compliant bladder member wherein said compliant bladder member is disposed between said housing and said mounting surface and wherein at least a portion of said housing is elastically deflectable relative to said enclosed volume.

25. The method of claim 24, wherein positioning further comprises:
attaching a plate to said mounting surface, wherein said compliant bladder member is attached to said plate.
